(19) United States
(12) Patent Application Publication
(10) Pub. No.: US 2012/0288311 A1
(43) Pub. Date: Nov. 15, 2012

(54) CHECKING SYSTEM, CONTROL METHOD OF CHECKING SYSTEM, AND STORAGE MEDIUM

(75) Inventor: Osamu Hosoda, Inagi-shi (JP)

(73) Assignee: CANON KABUSHIKI KAISHA, Tokyo (JP)

(21) Appl. No.: 13/463,261

(22) Filed: May 3, 2012

(30) Foreign Application Priority Data
May 10, 2011 (JP) 2011-105075

(51) Int. Cl. G03G 15/00

(52) U.S. Cl. 399/408

(57) ABSTRACT

A checking system for checking an image printed sheet includes a post processing control unit that performs control to execute binding of a sheet bundle containing a plurality of sheets determined to be normal based on a checking result and to discharge the sheet bundle to a first sheet discharge unit and a discharge control unit that performs control, in a case where a sheet is determined not to be normal, to discharge the sheet to a second sheet discharge unit, wherein in a case where a sheet is determined not to be normal cannot be discharged to the second sheet discharge unit, a sheet bundle containing the sheet determined not to be normal is discharged to the first sheet discharge unit without executing the binding.

### BACKGROUND OF THE INVENTION

1. Field of the Invention

The present invention relates to a checking system, a control method of checking system, and a storage medium.

2. Description of the Related Art

In a conventional printing apparatus, there is a problem that a stain adheres to a printed surface of a sheet or a printing position of an image deviates due to defective conveying of the sheet, while the sheet is conveyed. For easily finding out these stain and deviation of printing position, checking apparatuses have been considered. Japanese Patent Application Laid-Open No. 2005-31548 and Japanese Patent Application Laid-Open 2003-16259 discuss the checking apparatus which reads a printed surface of a sheet by an image reading apparatus, such as a scanner, and confirms that the read data is not different from the input data.

However, in these conventional examples, a post processing apparatus for a printed sheet, such as a stapling apparatus or a bookbinding processing apparatus attached to a printing apparatus, is not described. Therefore, when a user performs the post-processing, such as stapling or bookbinding processing, after printing, the post-processed product is bound including a sheet containing a defective image.

As a result, a user needs to manually remove binding needles of the bound processed products, to replace the defective sheet bound into the printed product containing a defective image with a normally printed sheet.

In other words, the conventional checking system is not suitably controlled to check whether binding processing is to be performed on a plurality of sheets containing a defective image in the check processing.

### SUMMARY OF THE INVENTION

According to an aspect of the present invention, a checking system for checking an image printed sheet includes a post processing control unit and a discharge control unit. The post processing unit performs control to execute binding of a sheet bundle containing a plurality of sheets determined to be normal based on a checking result and to discharge the sheet bundle to a first sheet discharge unit and a discharge control unit that performs control, in a case where a sheet is determined not to be normal, to discharge the sheet to a second sheet discharge unit, wherein in a case where a sheet is determined not to be normal cannot be discharged to the second sheet discharge unit, a sheet bundle containing the sheet determined not to be normal is discharged to the first sheet discharge unit without executing the binding.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of a printing system applied to a checking system.

FIG. 2 is a cross-sectional view showing an image forming apparatus illustrated in FIG. 1.

FIG. 3 is a block diagram illustrating a configuration of a control apparatus illustrated in FIG. 2.

FIG. 4 is a block diagram illustrating a configuration of a post processing apparatus illustrated in FIG. 2.

FIG. 5 is an example illustrating a high capacity sheets discharge apparatus connectable to the checking system.

FIG. 6 illustrates an outline of a sheet conveying path of the checking system according to the present exemplary embodiment.

FIG. 7 is a flowchart illustrating a control method of the checking system.

FIG. 8 is a flowchart illustrating a control method of the checking system.

FIG. 9 is a flowchart illustrating a control method of the checking system.

### DESCRIPTION OF THE EMBODIMENTS

Various exemplary embodiments, features, and aspects of the invention will be described in detail below with reference to the drawings.

### (Description of a Configuration of a System)

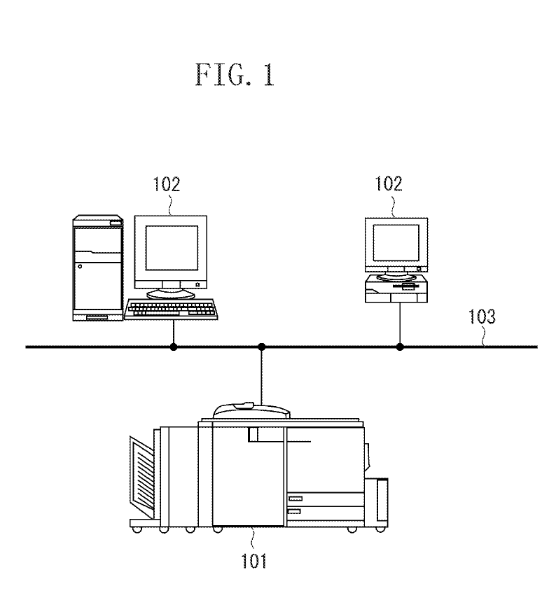

FIG. 1 illustrates a configuration of a printing system applied to a checking system according to a first exemplary embodiment of the present invention. The first exemplary embodiment describes an example of the checking system including a checking unit, which reads an image on the conveyed sheet and checks whether an image output on a sheet is a normal image.

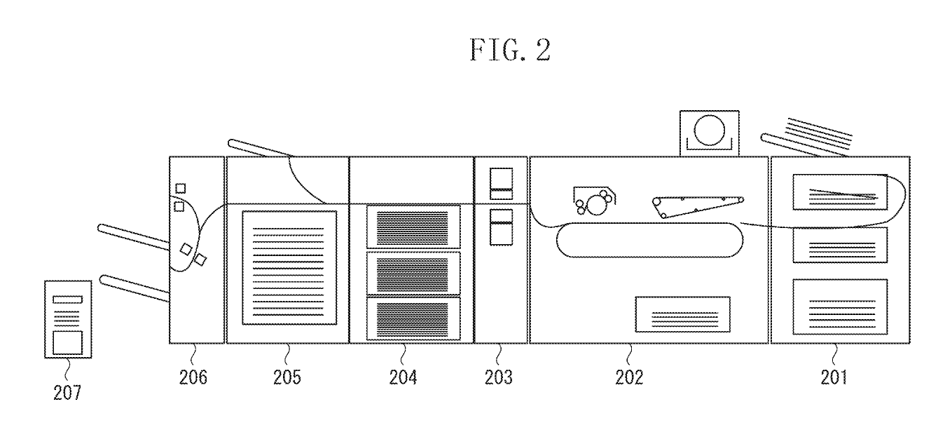

In FIG. 1, an image forming apparatus 101 includes a check processing unit and post processing unit as illustrated in FIG. 2. The check processing unit checks a state of an image of a printed sheet. The post processing unit performs binding processing on the sheet. A host computer 102 transmits print data to the image forming apparatus 101 via a network 103. In addition, on the network 103, the image forming apparatus 101 is configured to communicate with a host computer 102 which deals with various operation systems (OS), receive a print job, and perform set print processing.

In the printing system according to the present invention, the image forming apparatus 101 forms an image on a sheet fed from a feeding apparatus using print data formed from a print job received from the host computer 102.

FIG. 2 is a cross-sectional view showing a configuration of the image forming apparatus 101 illustrated in FIG. 1.

In FIG. 2, a sheet feeding apparatus 201 feeds a sheet to a printing apparatus 202. The sheet feeding apparatus 201 can feed various sizes and various sheets (a thick paper and a plain paper). A print apparatus 202 forms an image, for example, by performing an electrophotographic process, on a fed sheet.

In the first exemplary embodiment, an apparatus equipped with a print engine of a monochrome system will be described. However, the present invention can be applied to a print apparatus equipped with a print engine of 4 serially arranged tandem type for printing a color image.

Further, in the first exemplary embodiment, the print apparatus can form two-sided images on a sheet by controlling drive of a sheet feeding destination switching member, such as a flapper, and various conveyance rollers, which are not illustrated. Further, in a print job, when there is a layout designation such as Nin1, the image forming apparatus 101 can form an image by reducing a layout of images of a plurality of pages to fit into the designated sheet size.

A scanner apparatus 203 reads an image of a sheet output from the print apparatus 202. The scanner apparatus 203 can read two-sided images of a conveyed sheet.

An inserter 204 inserts a sheet to perform a specified partition processing at arbitrary timing during printing. The inserter 204 can store a plurality of sheet types (including an inserted sheet and a tab sheet) and select a sheet to be inserted depending on setting of print data.

A printed sheet is discharged to a stacker 205. The stacker 205 includes a stack unit and a sheet discharge tray unit. The stack unit stores large amounts of sheet. The sheet discharge tray unit has a configuration which enables an operator to easily confirm an output sheet. A post processing apparatus 206 performs stapling and binding of a printed sheet.

A control apparatus 207 controls each of the apparatuses 201 to 206. The control apparatus 207 connects to each apparatus by electrical signal lines. In this exemplary embodiment, the control apparatus 207 is configured as an external apparatus. However, a system controller provided in the print processing unit 202 can instead perform the functions of the control unit. In such a case, the system controller provided in the print processing unit 202 communicates to controllers provided in each of the apparatuses 203 to 206 and controls each function of the apparatuses.

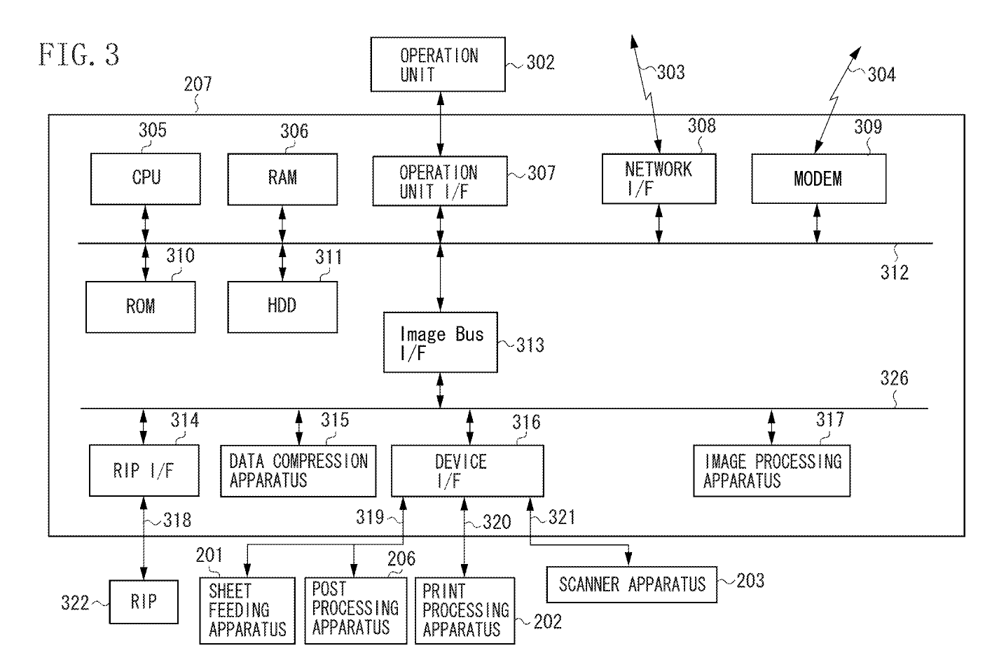

FIG. 3 is a block diagram illustrating a configuration of the control apparatus 207 illustrated in FIG. 2.

In FIG. 3, an operation unit 302 functions as a user interface for operating the image forming apparatus 101 and displays a user interface screen (not illustrated). In addition, the operation unit 302 is provided in the print apparatus 202. A network cable 303 communicably connects to external device. A public line cable 304 communicates with a facsimile apparatus which is an external device, with predetermined protocol. A central processing unit (CPU) 305 comprehensively controls each device connected to a CPU bus 312 and an image bus 326.

A random access memory (RAM) 306 is used as a work memory for storing programs which operates on the CPU 305. The RAM 306 is also used as a receiving buffer for temporally storing data received from an outside and as an image data buffer for temporally storing image data rasterized by a raster image processer (RIP).

An operation unit interface 307 connects an operation unit 302 and the control apparatus 207. A network interface (network I/F) 308 connects the control apparatus 207 and the network cable 303. A modem (MODEM) 309 connects to a public line. A read only memory (ROM) 310 stores programs and data which operate on the CPU 305.

A hard disk drive (HDD) 311 can store various data containing a print job and applications for the long term. An image bus 326 is connected to a hardware group, to perform image processing. An image bus interface (Image Bus I/F) 313 connects a CPU bus 312 and an image bus 326. A rasterizing board (RIP) 322 is connected to the image bus 326 via a RIP interface 314 and converts print data, which is based on page description language input from external, to bitmap image data.

An image transfer bus 318 outputs the bitmap image data converted by the RIP 322 to the RIP interface 314. A data compression apparatus 315 compresses the data. A device interface (device I/F) 316 is connected to the sheet feeding apparatus 201 and post processing apparatus 206 via an interface 319. Further, the device interface 316 is connected to the print apparatus 202 via an interface 320. Furthermore, the device interface 316 is connected to a scanner apparatus 203 via an interface 321.

An image processing apparatus 317 performs various image processing on the bitmap data formed by the RIP 322. The image processing apparatus 317 includes a function of digitally processing the bitmap image data, which combines the bitmap image data of 2 pages with bitmap image data of 1 page.

The CPU 305 controls the print apparatus 202, the sheet feeding apparatus 201, and the post processing apparatus 206 via interfaces according to signals instructed from the operation unit 302 or external devices via network cable 303.

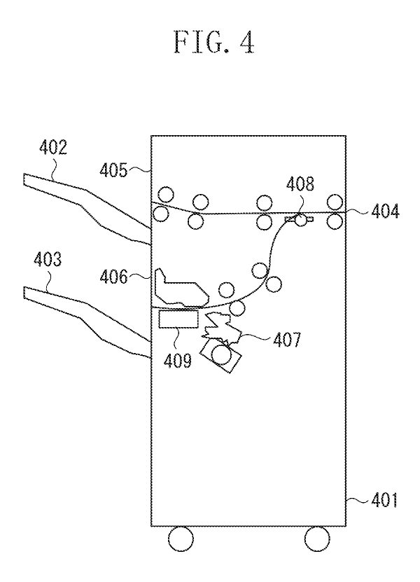

FIG. 4 is a cross-sectional view illustrating a structure of the post processing apparatus 206 as illustrated in FIG. 2. A post processing for performing binding on a sheet bundle will be described as follows. The sheet bundle is made of a plurality of stacked sheets with an image output according to a job instruction.

In FIG. 4, a main body 401 of the post processing apparatus is illustrated. A first sheet discharge tray 402 holds a discharged sheet. A second sheet discharge tray 403 holds a discharged sheet. An inlet 404 is provided at the main body 401 of the post processing apparatus through which a sheet is thrown out to the main body 401 of the post processing apparatus. A first sheet discharge unit 405 discharges a sheet to the first sheet discharge tray 402.

A second sheet discharge unit 406 discharges a sheet to the second sheet discharge tray 403. At the second sheet discharge unit 406, a standby buffer for post processing which temporarily stores a sheet at a time of stapling is provided. A staple processing unit 407 performs staple processing on a sheet to be discharged to the second discharge unit 406. A conveyance path switching apparatus 408 guides a sheet thrown out from the inlet 404 to the first sheet discharge unit 405 or the second sheet discharge unit 406.

A sheet thrown from the inlet 404 is switched by the conveyance path switching apparatus 408 and controlled by the staple processing unit 407 according to an instruction from the control apparatus 207, so that the post-processed sheet is discharged to the second sheet discharge unit 406. The second sheet discharge unit 406 is controlled so as to store the sheet in the standby buffer for post processing in the second sheet discharge unit 406 until all sheets to be stapled are collected.

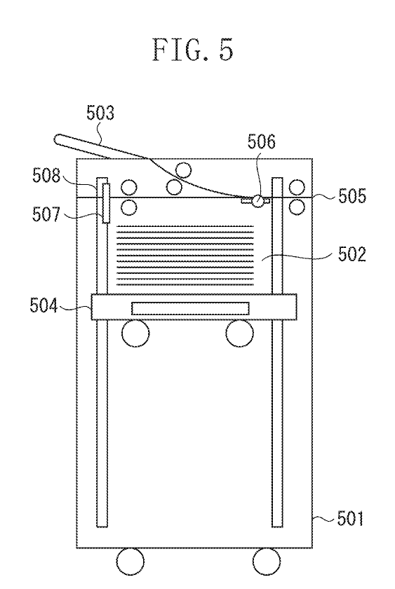

FIG. 5 is an example illustrating a high capacity sheet discharge apparatus connectable to the checking system according to the first exemplary embodiment. This example functions as a stacker for stacking the discharged sheet.

In FIG. 5, the main body 501 of the high capacity sheet discharge apparatus is illustrated. A stack unit 502 stores large amounts of printed sheets. A stacker discharge tray 503 enables an operator to easily take out a small amount of sheets.

A transport apparatus 504 transports the sheet stored in the stack unit 502 to the outside of the stacker 501. The transport apparatus 504 includes tires and handles, so that an operator can easily transfer the printed sheet. The high capacity sheet discharge apparatus has an inlet 505 through which a sheet is thrown out to the stacker 501.

A first switching apparatus 506 guides a sheet thrown from the inlet 505 to the sheet discharge tray 503. A switching apparatus 507 guides a sheet thrown from the inlet 505 to the stack unit 502. A sheet discharge unit 508 discharges a sheet thrown from the inlet 505 to an apparatus in a subsequent stage without storing it in the stack unit 502 and the sheet discharge tray 503.

The first switching apparatus 506 and the switching apparatus 507 are configured to control a conveyance direction of a sheet placed before each switching apparatus according to an instruction from the control apparatus 207.

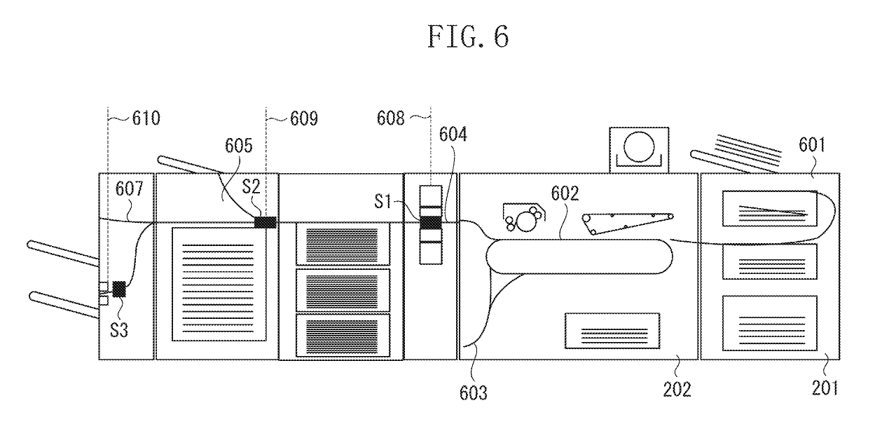

FIG. 6 illustrates an outline of a sheet conveyance path of the checking system according to the first exemplary embodiment. In FIG. 6, a conveyance path 601 for feeding a sheet conveys a sheet supplied from the sheet feeding apparatus 201. A conveyance path 602 for printing is used to convey a sheet fed from the sheet feeding apparatus 201 into the print apparatus 202. A conveyance path 603 for sheet reversing is used to reverse a sheet conveyance direction in the print apparatus 202. A conveyance path for scanner 604 makes a sheet pass through it to perform scanning in the scanner apparatus 203.

A conveyance path 605 for stacker is used, in the stacker 205, to feed a sheet to the stack unit 502, the sheet discharge tray 503, or an apparatus in a subsequent stage. A path 607 for post processing is used, in the post processing apparatus 206, to perform staple processing or discharging to a discharge tray. In a first sheet conveyance position 608, the scanner apparatus 203 reads a sheet. In a second sheet conveyance position 609, switching processing for conveying the printed sheet to the sheet discharge tray 503 is performed. A third sheet conveyance position 610 is a position where a sheet group to be stapled temporarily waits in the standby buffer for post processing.

S1, S2, and S3 are sensors, which detect the sheet being conveyed in the conveyance path, and notify the detected information to the CPU in the image processing apparatus 300. Therefore, after detecting the presence or absence of the sheet detected by the sensor S3, the CPU in the image processing apparatus 300 determines whether an image is normal by comparing the image on the sheet with target image data. When the CPU determines that the image on the sheet is not normal, the CPU switches the conveyance destination of the sheet depending on whether the sensor S2 has detected the sheet. By this processing, the CPU in the image processing apparatus 300 checks a combination of output from the sensor S1, S2, and S3, and can detect and specify the conveyance position of the sheet which has completed image reading and has been conveyed to the downstream side.

More specifically, when the sensor S1 is in an ON state and the sensor S2 is in an OFF state, the CPU in the image processing apparatus 300 can detect that the sheet is being conveyed before the stacker sheet discharge tray. Further, when the sensor S2 is in an ON state and the sensor S3 is in an OFF state, the CPU in the image processing apparatus 300 can detect that the sheet is being conveyed between the stacker sheet discharge tray and the post processing standby buffer unit. Furthermore, when the sensor S2 is in an OFF state and the sensor S3 is in an ON state, the CPU in the image processing apparatus 300 can detect that the sheet has been already discharged to the sheet discharge tray. Accordingly, the sensors S1 to S3 are used to detect the conveyance position of the sheet of an image which is detected not to be normal.

In the checking system according to the first exemplary embodiment, a sheet cannot stand by at a position other than the third sheet conveyance position 610.

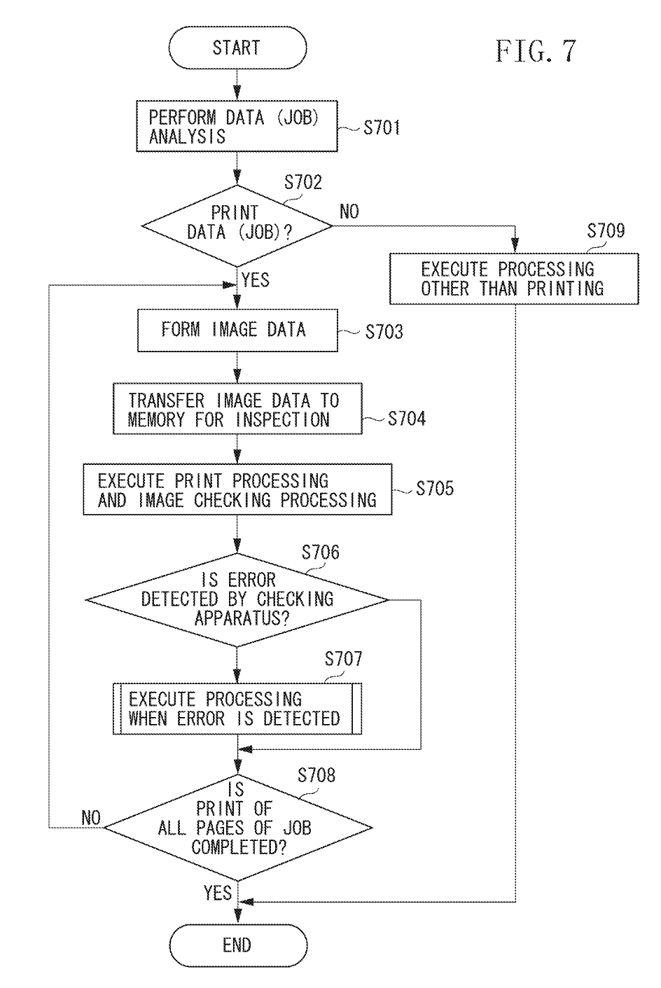

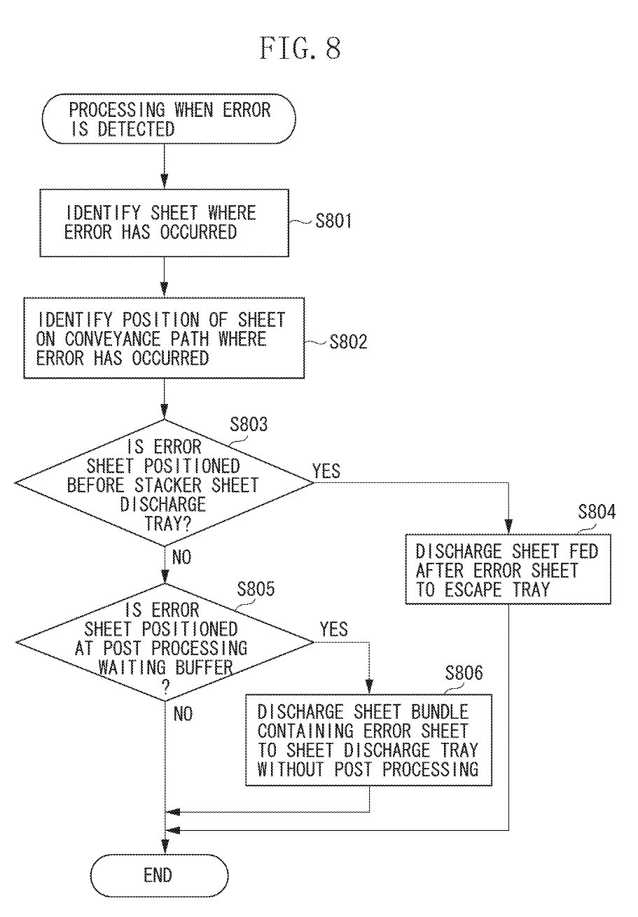

FIG. 7 and FIG. 8 are flowcharts illustrating a control method of the image forming apparatus 101 according to the first exemplary embodiment of the present invention. The control apparatus 207 controls each apparatus constituting the image forming apparatus 101 according to the control steps illustrated in FIG. 7 and FIG. 8.

The control method of the image forming apparatus 101 according to the present invention will be described referring to the flowcharts illustrated in FIG. 7 and FIG. 8.

FIG. 7 is a flowchart illustrating a control method of the checking system according to the first exemplary embodiment. The present example is a control procedure for processing a print job received from the host computer 102 via the network cable 303 or a copy job generated by an operator handling the operation unit 302. Each step is realized by the CPU 305 loading control programs stored in the ROM 310 or the HDD 311 to the RAM 306 and executing them.

Further, in the first exemplary embodiment, the CPU 305 performs control such that generated various jobs are stored in the RAM 306 as digital data when these jobs are generated.

In step S701, the CPU 305 analyses data of a job stored in a buffer area of the RAM 306. In step S702, the CPU 305 determines whether the analyzed job needs print processing, from the result of the analysis in step S701. When the CPU 305 determines that the job does not need the print processing (NO in step S702), the processing proceeds to step S709. In step S709, the CPU 305 executes processing other than print processing and ends the processing.

On the other hand, in step S702, if the CPU 305 determines that the analyzed job needs the print processing (YES in step S702), the processing proceeds to step S703. In step S703, the CPU 305 generates print target image data based on a set value and data of the job and stores the generated data in the RAM 306. In step S704, the CPU 305 transfer the image data generated in step S703 to an exclusive area for performing image checking in the RAM 306.

In step S705, the CPU 305 performs control to carry out the print processing and the image check processing independently and in parallel based on the information analyzed in step S701.

In the print processing, according to an instruction from the CPU 305, a sheet is fed from the sheet feeding apparatus 201, and image forming processing is performed in the print apparatus 202. Further, according to the instruction, insert processing from the inserter 204, discharging to the stack unit in the stacker 205, and post processing by the post processing apparatus 206 are carried out.

Further, in step S705, the scanner apparatus 203 reads an image formed by the print apparatus 202 on the fed sheet and the CPU 305 compares the read image by the scanner apparatus 203 with the image data stored in the image checking area in the RAM 306.

In step S706, the CPU 305 determines whether there is a difference between the image read by the scanner apparatus 202 and the image data stored in the RAM 306, from the result of the comparison in step S705. In this step, it is possible to detect dirt or blur on the image formed sheet, which are not contained in the original image.

When the CPU 305 determines that there is a difference between the image read by the scanner apparatus 202 and the image stored in the image checking area in the RAM 306 (YES in step S706), the CPU 305 determines that the image is a defective image and the processing proceeds to step S707. In step S707, the CPU 305 executes the processing which is performed when an error is detected. The processing when the error is detected will be described later, referring to FIG. 8.

In step S708, the CPU 305 determines whether the processing of all pages contained in the job is completed. When the CPU 305 determines that there is a page not completed in the processing (NO in step S708), the processing proceeds to step S703, to process the remained pages.

On the other hand, in step S708, when the CPU 305 determines that the processing of all pages contained in the job is completed (YES in step S708), the processing ends.

FIG. 8 is a flowchart illustrating a control method of the checking system according to the first exemplary embodiment. The first exemplary embodiment is a control procedure when the processing is performed at a time of detecting the error in step S707 illustrated in FIG. 7. Each step is realized by the CPU 305 loading control programs stored in the ROM 310 or the HDD 311 to the RAM 306 and executing them.

In step S801, the CPU 305 identifies the sheet on which the image data compared in step S706 is printed.

In step S802, the CPU 305 determines where the sheet identified in step S801 is positioned on the sheet conveyance path of the inserter 204, the stacker 205, or the post processing apparatus 206, based on the identified sheet information. On the conveyance path, sensors for monitoring the conveyed sheet are provided and the sensor information is notified to the CPU 305.

In step S803, the CPU 305 determines whether an error sheet of the image determined not to be normal in step S801 is positioned before the position 609, based on the output from the sensors S1 and S2. In the position 609, the switching apparatus 506 of the stacker sheet discharge tray is provided. If the CPU determines that the error sheet is positioned before the position 609 (YES in step S803), the processing proceeds to step S804.

In step S804, the CPU 305 switches the switching apparatus 506 of the stacker 205 and performs control such that already fed sheets following the error sheet are discharged to the sheet discharge tray 503 functioning as the second sheet discharge destination. Then, the processing ends. The sheet discharge tray 503 functions as a stacker discharge tray.

On the other hand, in step S803, if the CPU 305 determines that the error sheet identified in step S801 is not positioned before the position 609, which is the position of switching apparatus 506 of the stacker sheet discharge tray, based on the output from the sensors S1 and S2 (NO in step S803), the processing proceeds to step S805.

In step S805, the CPU 305 determines whether the error sheet identified in step S801 is positioned between the position 609 and the third sheet conveyance position 610, based on output from the sensors S2 and S3. If the CPU 305 determines that the error sheet identified in step S801 is positioned between the position 609 and the third sheet conveyance position 610, based on output from the sensors S2 and S3 (YES in step S805), the processing proceeds to step S806.

In step S806, even when the job is given an instruction to perform post processing, the CPU 305 does not perform the post processing on the error sheet and the sheet bundle stored in the standby buffer for post processing. The CPU 305 discharges the error sheet and the sheet bundle to the first sheet discharge tray 402 functioning as the first sheet discharge destination without performing the post processing, and then the present processing ends. The CPU 305 may perform control to discharge the error sheet and the sheet bundle to the second sheet discharge tray 403 as the first sheet discharge destination.

On the other hand, in step S805, if the CPU 305 determines that the error sheet identified in step S801 is not positioned between the position 609 and the third sheet conveyance position 610, based on the output from the sensors S2 and S3 (NO in step S805), the processing ends.

Accordingly, in the first exemplary embodiment, since the formation of the print products, which are post-processed is prevented together with the error sheet detected by the image check processing, an operator need not remove staples and bind sheets again when the operator binds a replacement page, at a time of additional printing.

In the aforementioned first exemplary embodiment, by comparing the image data and the image data scanned after forming an image, the defective image on the printed sheet is detected. When the CPU 305 determines that there is a defective image on the printed sheet, the CPU 305 controls the sheet discharge destination according to a position on the conveyance path of the sheet containing the defective image.

In the second exemplary embodiment, in addition to the aforementioned discharge control of a sheet, a re-output control method for re-printing the sheet containing a defective image will be described.

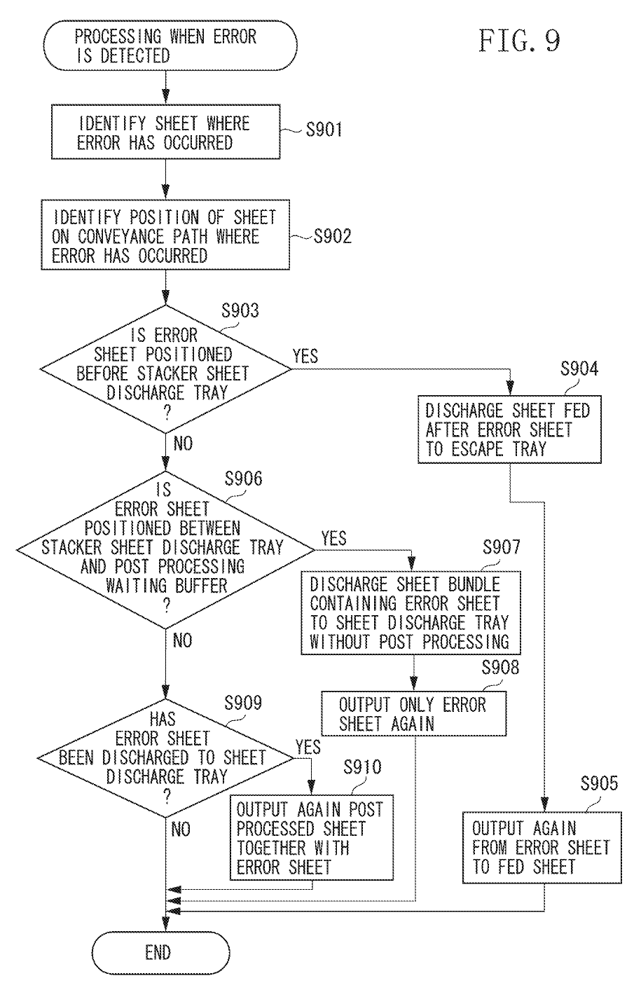

FIG. 9 is a flowchart illustrating a control method of the checking system according to the second exemplary embodiment. The second exemplary embodiment is another control procedure of the processing when an error illustrated in step S707 is detected and carries out re-output processing. Each step is realized by the CPU 305 loading control programs stored in the ROM 310 or the HDD 311 to the RAM 306 and executing them. In the second exemplary embodiment, the CPU 305 performs control to store generated various jobs in the RAM 306 as digital data when these jobs are generated.

Further, in the second exemplary embodiment, the processing other than step S707, which is the processing performed at a time of detecting an error, follows the processing in the first exemplary embodiment, so that its description is omitted.

In step S901, the CPU 305 identifies a sheet on which a non normal image is printed in the error detection processing of step S706.

In step S902, based on the sheet identified in step S901, the CPU 305 determines where the sheet is positioned on the sheet conveyance path of the inserter 204, stacker 205, or the post processing apparatus 206. On the conveyance path, sensors S1, S2, and S3 are provided to monitor the conveyed sheet, and the sensor information is notified to the CPU 305.

In step S903, the CPU 305 determines whether the sheet identified in step S901 is positioned before the position 609 where a switching apparatus 506 of the stacker sheet discharge tray is provided, based on output from the sensors S1 and S2. When the CPU 305 determines that the identified sheet is positioned before the position 609 where the switching apparatus 506 of the stacker sheet discharge tray is provided (YES in step S903), the processing proceeds to step S904.

In step S904, the CPU 305 performs switching processing by the switching apparatus 506 of the stacker 205 and performs control to convey the sheet identified in step S901 and the sheet fed from the sheet feeding apparatus 201 to the sheet discharge tray 503. Further, as the second re-output processing, in step S905, the CPU 305 performs control to re-output the sheet discharged to the discharge tray 503 in step S904 and ends the present processing.

On the other hand, in step S903, the CPU 305 determines that the identified sheet is not positioned before the position 609 where the switching apparatus 506 of the stacker sheet discharge tray is provided, based on the output from the sensors S1 and S2 (NO in step S903), the processing proceeds to step S906. In step S906, the CPU 305 determines whether the sheet identified in step S901 is positioned between the position 609 and the third sheet conveyance position 610, based on the output from the sensors S2 and S3. When the CUP 305 determines that the sheet identified in step S901 is positioned between the position 609 where the switching apparatus 506 of the stacker sheet discharge tray is provided, and the third sheet conveyance position 610 where the standby buffer 409 for the post processing (YES in step S906) is provided, the processing proceeds to step S907.

In step S907, even when the job is given an instruction to perform post processing, the CPU 305 does not perform the post processing and performs control to discharge the sheet and the sheets stored in the standby buffer for post processing to the first sheet discharge unit and the second sheet discharge unit of the post processing apparatus 206.

As the first re-output processing, in step S908, the CPU 305 performs control to re-output the sheet identified in step S901 and ends the present processing.

On the other hand, when the CUP 305 determines that the sheet identified in step S901 is not positioned between the position 609 and the third sheet conveyance position 610, based on the output from the sensors S2 and S3 (NO in step S906), the processing proceeds to step S909. In step S909, the CPU 305 determines whether the sheet identified in step S901 has been discharged to the sheet discharge tray of the post processing apparatus, based on the output of the sensor S3. When the CPU 305 determines that the sheet identified in step S901 has been discharged to the sheet discharge tray of the post processing apparatus (YES in step S909), the processing proceeds to step S910.

In step S910, the CPU 305 performs control to re-output all post-processed sheets together with the sheet identified in step S901 and ends the processing.

On the other hand, when the CPU 305 determines that the sheet identified in step S901 has not been discharged to the sheet discharge tray of the post processing apparatus based on the output of S3 (NO in step S909), the CPU 305 ends the processing.

As described above, according to the second exemplary embodiment, when an image is not normal in the image check processing, the CPU 305 can obtain a proper print result by switching the additional print method to be carried out after the sheet is conveyed, according to the conveyance position of the conveyed error sheet. A user can perform staple processing on the proper printed sheet bundle by replacing the error sheet with the re-output sheet, without any operation of removing staples.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-105075 filed May 10, 2011, which is hereby incorporated by reference herein in its entirety.

What is claimed is:

1. A checking system for checking an image printed sheet, comprising:
a post processing control unit configured to perform control to execute binding of a sheet bundle containing a plurality of sheets determined to be normal based on a checking result and to discharge the sheet bundle to a first sheet discharge unit; and
a discharge control unit configured to perform control, in a case where a sheet is determined not to be normal, to discharge the sheet to a second sheet discharge unit,
wherein in a case where a sheet is determined not to be normal cannot be discharged to the second sheet discharge unit, a sheet bundle containing the sheet determined not to be normal is discharged to the first sheet discharge unit without executing the binding.

2. The checking system according to claim 1,
wherein the discharge control unit is further configured to perform control, in a case where a sheet determined not to be normal, to discharge the sheet and subsequent already fed sheets to the second sheet discharge unit.

3. The checking system according to claim 2, further comprising:
a printing control unit configured to perform control, after the sheet and the subsequent already fed sheets are discharged to the second sheet discharge unit, to re-print images to be printed on the sheet and the subsequent already fed sheets.

4. The checking system according to claim 1, further comprising:
a printing control unit configured to, in a case where the sheet determined not to be normal cannot be discharged to the second sheet discharge unit, not execute binding of a sheet bundle containing the sheet determined not to be normal and after discharging the sheet bundle to the first sheet discharge unit, to re-print an image to be printed on the sheet determined not to be normal.

5. A control method for controlling a checking system for checking an image printed sheet, comprising
performing control to execute binding of a sheet bundle containing a plurality of sheets determined to be normal based on a checking result and to discharge the sheet bundle to a first sheet discharge unit;
performing control, in a case where a sheet is determined not to be normal, to discharge the sheet to a second sheet discharge unit; and
performing control, in a case where a sheet is determined not to be normal cannot be discharged to the second sheet discharge unit, to discharge a sheet bundle containing the sheet determined not to be normal to the first sheet discharge unit without executing the binding.

6. A computer readable storage medium for storing a computer program for controlling a checking system which checks an image printed sheet, the computer program comprising:
performing control to execute binding of a sheet bundle containing a plurality of sheets determined to be normal based on a checking result and to discharge the sheet to a first sheet discharge unit;
performing control, in a case where a sheet is determined not to be normal, to discharge the sheet to a second sheet discharge unit; and
performing control, in a case where a sheet determined not to be normal cannot be discharged to the second sheet discharge unit, to discharge a sheet bundle containing the sheet determined not to be normal to the first sheet discharge unit without executing the binding.
